(19) United States
(12) Patent Application Publication
(10) Pub. No.: US 2017/0206546 A1
(43) Pub. Date: Jul. 20, 2017

(54) SYSTEM AND METHOD FOR STRUCTURING RETAIL DEALS FOR A DISCOUNTING SERVICE

(71) Applicant: ORACLE INTERNATIONAL CORPORATION, Redwood Shores, CA (US)

(72) Inventors: Raymond MARTIN, Upton, MA (US); Carl A. MILANO, Chardon, OH (US); Patrick L. TAN, Solon, OH (US); Hang Kin TSANG, Lancashire (GB); Sandra L. THEM, Twinsburg, OH (US); Lorraine M. STEINER, Hiram, OH (US)

(21) Appl. No.: 14/995,267

(22) Filed: Jan. 14, 2016

(51) Int. Cl. G06Q 30/02; G06F 3/0484

(52) U.S. Cl. CPC G06Q 30/0238; G06F 3/04842

(57) ABSTRACT

Embodiments are disclosed that provide a deal structuring interface tool. The tool may be used to select a deal template that provides a computerized structure for generating transaction offsets used to discount retail transactions. The deal template can be transformed into a computerized discount object by structuring discount rules within the deal template to represent a transaction offset. The computerized discount object can be saved to an application server that is configured to apply transaction offsets to retail transactions. The computerized discount object can be associated with eligibility rules that specify eligibility for a retail transaction to be modified by a transaction offset. Customer data can be received from a point-of-sale system in response to a retail transaction being initiated at a retail store. The customer data can be compared to the eligibility rules to determine whether the retail transaction is eligible to be modified by the transaction offset.

### BACKGROUND

The processing of promotional discounts for retail items can be complex. There may be many rules governing the eligibility and application of discounts to retail transactions by customers. Different transaction systems, provided at a retail store or as part of an on-line retail e-commerce system, may have their own dedicated discounting platforms. Variability exists between the vendors of such transaction systems. From a customer perspective, an offer that is presented at one retail store may apply a discount in one way, and the same offer presented at a different retail store with a same basket of items may apply the discount in another way. This can lead to dissatisfaction and mistrust on the part of customers, resulting in customer service issues for the retailer.

Furthermore, to provide discounting services, a retailer typically has to submit separately defined discount deals to multiple transaction systems across multiple retail stores. Each defined discount deal has a set of customer eligibility rules that are integrally defined as a property of the discount deal. Managing such discount deals across many different transaction systems can be very difficult and time consuming for a retailer.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with a deal structuring interface tool;

FIG. 2 illustrates one embodiment of a method, which can be performed using the deal structuring interface tool of the computer system of FIG. 1, to structure discount deals that are separate from customer eligibility rules;

FIG. 3 graphically illustrates an example embodiment of a screen shot, provided by a graphical user interface of the deal structuring interface tool of FIG. 1, to facilitate the associating of customer eligibility rules to discount deals by a user;

FIG. 4 graphically illustrates another example embodiment of a screen shot, provided by a graphical user interface of the deal structuring interface tool of FIG. 1, to facilitate the associating of customer eligibility rules to discount deals by a user; and

FIG. 5 illustrates one embodiment of a computing device upon which a deal structuring interface tool of a computing system may be implemented.

### DETAILED DESCRIPTION

When a customer at a retail store desires to purchase, for example, a basket of retail items, the customer may be eligible for certain discount deals. Depending on current circumstances and the nature of the retail items in the basket, the customer may be in a prime position to save money on the customer transaction if one or more discount deals offered by the retailer can be applied to the customer transaction.

Systems, methods, and other embodiments are disclosed that provide for the structuring of core discount deals for retail items independent of the individual retail stores (sales channels). Furthermore, embodiments provide for the structuring and storing of a core discount deal separately from the eligibility rules that are used to determine whether a customer/retail transaction is eligible to take advantage of the core discount deal, which applies a transaction offset (e.g., a price offset that reduces the cost of the retail transaction).

In one embodiment, a deal structuring interface tool, having a graphical user interface, is provided that allows a user to structure core discount deals using templates, and associate the core discount deals with customer eligibility rules. In accordance with one embodiment, a core discount deal is structured as a computerized discount object via the deal structuring interface tool and stored in a deal engine that is external to the deal structuring interface tool. The computerized discount object is associated with a set of customer eligibility rules that are structured in the deal structuring interface tool.

Customer data, from a point-of-sale system, may be received by the deal structuring interface tool in response to a customer initiating a retail transaction at a retail store. The customer data may be analyzed by the deal structuring interface tool with respect to the eligibility rules associated with the computerized discount object to determine whether the retail transaction (for the customer) is eligible to take advantage of the core discount deal by modifying the retail transaction by the transaction offset.

Upon determining that the retail transaction is eligible, the deal structuring interface tool can generate a computer message which identifies the computerized discount object. The computer message can be transmitted to the point-of-sale system to control discounting of the retail transaction by applying the transaction offset by the deal engine based on the computerized discount object.

The following terms are used herein with respect to various embodiments.

The term “item” or “retail item”, as used herein, refers to merchandise sold, purchased, and/or returned in a sales environment.

The term “sales channel” or “location” or “retail location”, as used herein, may refer to a physical store where an item is sold, or to an on-line store via which an item is sold.

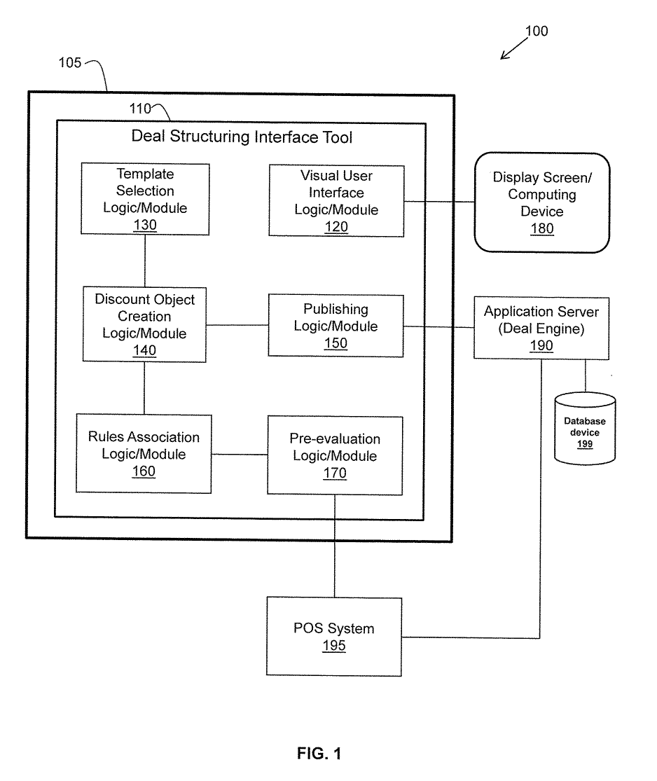

FIG. 1 illustrates one embodiment of a computer system 100 (e.g., a retail discounting service system), having a computing device 105 configured with a deal structuring interface tool 110. For example, in one embodiment, the deal structuring interface tool 110 may be part of a larger computer application (e.g., a computerized retail discounting application), configured to manage customer discounts across multiple retail sales channels of a retailer. In one embodiment, the system 100 is a computing/data processing system including an application or collection of distributed applications for enterprise organizations. The applications and computing system 100 may be configured to operate with or be implemented as a cloud-based networking system, a software-as-a-service (SaaS) architecture, or other type of computing solution.

The deal structuring interface tool 110 is configured to facilitate user interaction to generate core discount deals (transaction offsets) and associate customer eligibility rules with the core discount deals in a flexible manner. The embodiments described herein separate core discount deals from customer eligibility rules such that core discount deals (transaction offsets) can be created and/or updated independently of the customer eligibility rules.

The deal structuring interface tool 110 is also configured to computerize the process of analyzing customer data to determine the eligibility of a retail transaction of a customer with respect to taking advantage of a core discount deal (i.e., determine whether the retail transaction is eligible to be modified by a transaction offset). In one embodiment, a computer algorithm is disclosed that implements an analytical approach for evaluating customer eligibility independent of applying a discount deal to a customer transaction.

With reference to FIG. 1, in one embodiment, the deal structuring interface tool 110 is implemented on the computing device 105 and includes logics or modules for implementing various functional aspects of the deal structuring interface tool 110. In one embodiment, the deal structuring interface tool 110 includes visual user interface logic/module 120, template selection logic/module 130, discount object creation logic/module 140, publishing logic/module 150, rules association logic/module 160, and pre-evaluation logic/module 170.

Other embodiments may provide different logics or combinations of logics that provide the same or similar functionality as the deal structuring interface tool 110 of FIG. 1. In one embodiment, the deal structuring interface tool 110 is an executable application including algorithms and/or program modules configured to perform the functions of the logics. The application is stored in a non-transitory computer storage medium. That is, in one embodiment, the logics of the deal structuring interface tool 110 are implemented as modules of instructions stored on a computer-readable medium.

In one embodiment, visual user interface logic 120 is configured to generate a graphical user interface (GUI) to facilitate user interaction with the deal structuring interface tool 110. For example, visual user interface logic 120 includes program code that generates and causes the graphical user interface to be displayed based on an implemented graphical design of the interface. In response to user actions and selections via the GUI, associated aspects of structuring core discount deals, generating customer eligibility rules, and associating the core discount deals with the customer eligibility rules are performed.

The computer system 100 also includes a display screen 180 operably connected to the computing device 105 (e.g., to visual user interface logic 120). In accordance with one embodiment, the display screen 180 is implemented to display views of and facilitate user interaction with the graphical user interface (GUI) generated by visual user interface logic 120 (e.g., for viewing and updating information associated with structuring core discount deals and associating the core discount deals with customer eligibility rules). The graphical user interface may be associated with a deal structuring interface application, in accordance with one embodiment.

In one embodiment, the computing device 105 is a centralized server-side application that provides at least the functions disclosed herein and that is accessed by many users via computing devices/terminals communicating with the computing device 105 (functioning as the server) over a computer network. Thus the display screen 180 may represent multiple computing devices/terminals that allow users to access and receive services from the deal structuring interface tool 110 via networked computer communications.

For purposes of description, it is assumed herein that the application of discount deals (transaction offsets) to customer retail transactions is performed in real time by an application server 190 of the system 100, configured as a deal engine, in cooperation with a point-of-sale system 195 of the system 100. The point-of-sale system 195 is associated with a sales channel of a retailer (e.g., a particular physical store or a particular on-line store). It is also assumed herein that evaluation of customer eligibility with respect to a discount deal is performed in real time by the deal structuring interface tool 110 in cooperation with the same point-of-sale system 195. However, other configurations that also evaluate customer eligibility independent of applying a discount deal are possible as well in accordance with other embodiments. In one embodiment, the point-of-sale system 195 is a server computer at a retail store.

In one embodiment, the computer system 100 further includes at least one database device 199 operably connected to the deal engine 190. For example, the deal engine 190 may be operably connected to the database device 199 via a network interface to access the database device 199 via a network connection. In accordance with one embodiment, the database device 199 is configured to store and manage a library of computerized discount objects representing core discount deals (transaction offsets) that are created by the deal structuring interface tool 110. A computerized discount object may include data structures having discount rules that characterize or define a core discount deal (transaction offset). The discount rules may include trigger rules and award rules. In one embodiment, the deal engine 190 is configured such that the trigger rules cause (trigger) the award rules to be applied to a retail transaction to affect a discount.

Referring again to FIG. 1, in one embodiment, template selection logic 130 is configured to facilitate a selection of a deal template by a user via the graphical user interface provided by visual user interface logic 120. The deal template provides a computerized structure for generating discount deals (transaction offsets) used to discount (modify) retail transactions. Multiple deal templates may be available from which to select. Each deal template may correspond to a different generic type of discount deal which can be transformed into a specific deal (transaction offset). Discount deals may involve, for example, coupons, price reductions, free shipping, saving more when buying more, buying x units and getting y additional free units, price matching, and loyalty points. Other aspects of discount deals are possible as well.

In one embodiment, discount object creation logic 140 is configured to transform the selected deal template into a computerized discount object. The transformation is accomplished by facilitating a structuring of discount rules by the user, via the graphical user interface, within the deal template to represent a specific deal (transaction offset). The discount rules may be structured within the deal template by selecting the discount rules from a set of pre-defined discount rules, and/or by generating the discount rules anew. The discount rules may include trigger rules and award rules. The trigger rules cause (trigger) the award rules to be applied to a retail transaction to affect a discount. As an example, a trigger rule may involve detecting that a customer has two (2) sweaters in a basket of items to be purchased. Upon detection of the two (2) sweaters, the trigger rule may trigger an award rule defined as “buy a first sweater and get a second sweater for half price”. As a result, the price of the second sweater gets discounted (modified) by 50%.

In one embodiment, publishing logic 150 is configured to transmit the computerized discount object (having the discount rules) to the application server (deal engine) 190 to be stored. The transmission may take place, for example, over a computer network such as, for example, the internet. It is the deal engine 190 that applies discount deals (i.e., the discount rules) to customer retail transactions received from the point-of-sale (POS) system 195. In one embodiment, the deal engine 190 stores the computerized discount object in a library of deals configured in the database device 199.

In one embodiment, rules association logic 160 is configured to facilitate the user being able to, via the graphical user interface, generate (or select) customer eligibility rules and associate a computerized discount object with the customer eligibility rules. The customer eligibility rules specify customer eligibility for taking advantage of a specific deal defined in the computerized discount object by the discount rules. That is, the eligibility rules specify an eligibility for a customer retail transaction to be modified by a transaction offset. Customer eligibility rules may define eligible sales channels (i.e., eligible retail stores), eligible times of day, eligible days of the week, and an eligible number of available redemptions for the specific deal, for example. The current circumstances of the customer have to conform to the eligibility rules before the customer can take advantage of the specific deal.

In one embodiment, pre-evaluation logic 170 is configured to receive customer data from the point-of-sale system 195 at a retail store in response to a customer initiating a retail transaction via the retail store. The customer data captures the current circumstances of the customer. For example, the customer data may include data identifying the customer (e.g., based on a loyalty card), data identifying the retail store, data identifying the current time of day, and data identifying the current day of the week. Pre-evaluation logic 170 is also configured to analyze the customer data, for example, by comparing the customer data to the eligibility rules associated with the computerized discount object to determine whether the customer is currently eligible to take advantage of the specific deal (i.e., to determine whether a current retail transaction of the customer is eligible to be modified by a particular transaction offset). Pre-evaluation logic 170 effectively pre-evaluates the customer before the customer is allowed to take advantage of any discount deal.

Pre-evaluation logic 170 is further configured to, upon determination that the customer is currently eligible to take advantage of the specific deal, generate a computer message that identifies the computerized discount object, and transmit the computer message to the point-of-sale system 195 (e.g., via network communications). The computer message, at the point-of-sale system 195, may be used to control discounting (modification) of the retail transaction of the customer by the deal engine 190 based on the identified computerized discount object in the computer message. In one embodiment, the deal engine 190 is configured to apply the specific deal (specific transaction offset), defined in the computerized discount object, to a retail transaction of a customer by reducing a price associated with the retail transaction.

As an example, a customer may initiate a customer transaction at a retail store with respect to purchasing a basket of retail items. The customer may present a loyalty card as part of initiating the customer transaction. The point-of-sale system 195 at the retail store sends customer data to pre-evaluation logic 170 of the deal structuring interface tool 110 (e.g., via network communications). The customer data includes data from the loyalty card as well as data identifying the retail store, the current date and time, and possibly other parameters associated with the current customer scenario.

Continuing with the example, pre-evaluation logic 170 analyzes the customer data and determines that the customer is eligible for a particular discount deal. Pre-evaluation logic 170 then generates and sends a computer message identifying a computerized discount object that defines the discount deal back to the point-of-sale system 195. The point-of-sale system 195 sends transaction data, corresponding to the initiated customer retail transaction, to the deal engine 190 (e.g., via network communications) along with the identifier of the computerized discount object. The transaction data includes information about the basket of retail items (identification of retail items, price, quantity, etc.).

Further continuing with the example, the deal engine 190 analyzes the transaction data with respect to trigger rules of the computerized discount object and triggers the award rules of the computerized discount object to be applied to the customer transaction. The deal engine 190 applies the award rules to the customer transaction which results in modifying the customer retail transaction by applying a discount (transaction offset) to the customer retail transaction (e.g., reducing a price of a retail item in the basket of retail items). The deal engine 190 sends the modified (marked-up) customer transaction back to the point-of-sale system 195 where the purchase of the basket of retail items by the customer is completed with the applied discount.

In this manner, computerized discount objects defining core discount deals can be generated, stored, and processed separately from customer eligibility rules. As a result, discount deals can be generated or updated independent of the eligibility rules. Furthermore, a customer transaction can be evaluated with respect to customer eligibility before applying a discount deal to the customer transaction. If a customer is determined to be ineligible for a discount deal, then the system 100 does not have to waste time and resources applying the discount deal. This results in a retailer being able to provide a more efficient discounting service. Also, each POS system at each retail store does not have to be configured with discount deals. All discount deals for all retail stores may be handled by a common application server configured as a deal engine.

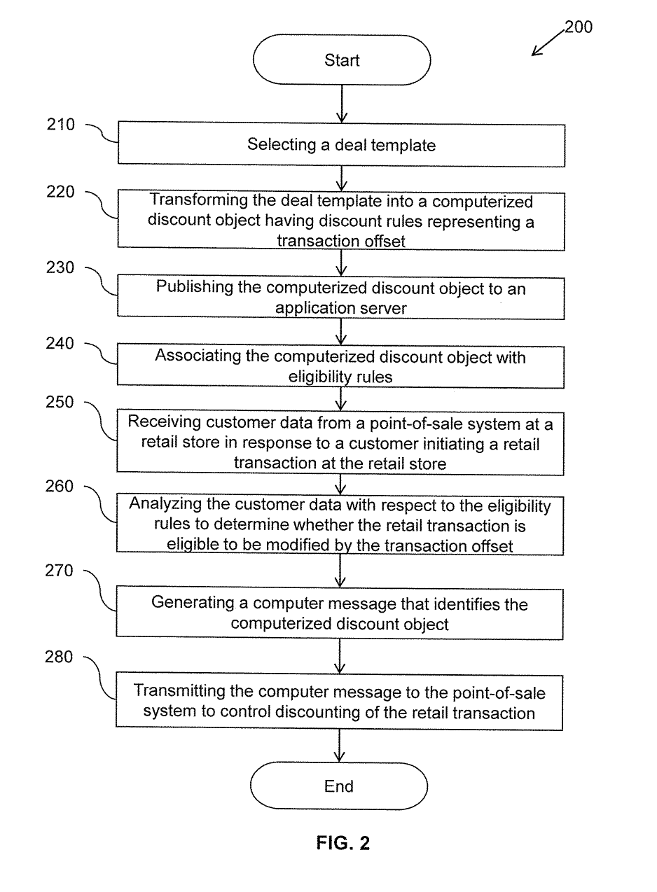

FIG. 2 illustrates one embodiment of a method 200, which can be performed using the deal structuring interface tool 110 of the computer system 100 of FIG. 1, to structure discount deals that are separate from customer eligibility rules. Method 200 describes operations of the deal structuring interface tool 110 and is implemented to be performed by the deal structuring interface tool 110 of FIG. 1, or by a computing device configured with an algorithm of the method 200. For example, in one embodiment, method 200 is implemented by a computing device configured to execute a computer application. The computer application is configured to process data in electronic form and includes stored executable instructions that perform the functions of method 200.

Method 200 will be described from the perspective that a deal structuring discount tool 110 is provided that allows a user to set up discount deals and other associated rules in the discounting service system 100. Method 200 will also be described from the perspective that, for customers making purchases of retail items at a retail store, the point-of-sale system 195 associated with the retail store interacts with the deal structuring interface tool 110 and the deal engine 190 to actively discount purchases.

Upon initiating method 200, at block 210, a user selects a deal template from multiple deal templates. The deal template provides a computerized structure for generating deals (transaction offsets) used to discount retail transactions. The user may select a deal template based on the type of deal that the user desires to implement. At block 220, the user transforms the deal template to form a computerized discount object by structuring discount rules within the deal template which represent a specific deal (a specific transaction offset). The computerized discount object may include discount rules in the form of data structures having instructions and data that define a specific deal. For example, in one embodiment, a computerized discount object is in the form of a Java applet, where transforming the deal template also includes compiling the deal template, as structured with the discount rules, to create the Java applet. In one embodiment, the discount rules, representing the specific deal, include rules associated with a quantity and a price of a retail item.

At block 230, the computerized discount object is published (i.e., transmitted and saved in a computerized storage) to an application server configured as a deal engine 190 for applying deals to customer retail transactions. The deal engine 190 may be external to (e.g., remote to) the deal structuring interface tool 110 and the point-of-sale system 195. In one embodiment, the computerized discount object is stored in a library of deals configured in the database device 199 which is associated with the deal engine 190. Furthermore, the deal engine 190 transmits an identifier, which identifies the computerized discount object as saved, back to the deal structuring interface tool 110, in accordance with one embodiment.

At block 240, the user associates the computerized discount object with one or more customer eligibility rules. The eligibility rules specify or characterize customer eligibility for taking advantage of the specific deal defined by the computerized discount object. The user may generate or select the customer eligibility rules to be associated with the computerized discount object.

In accordance with one embodiment, the customer eligibility rules may specify eligible retail stores, eligible times of day, eligible days of the week, and an eligible number of available redemptions for the specific deal.

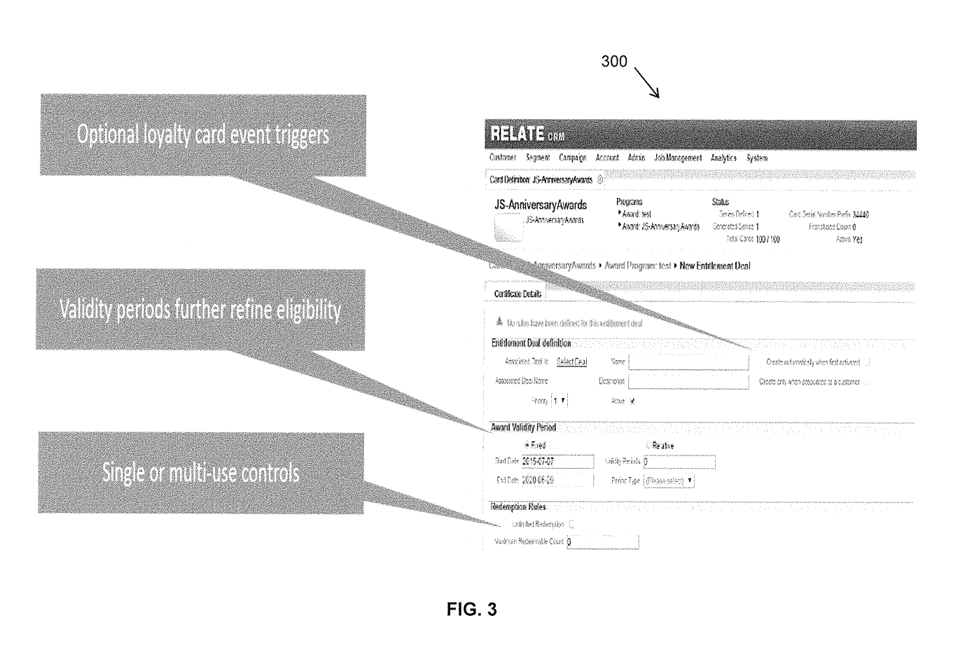

FIG. 3 illustrates an example embodiment of a screen shot 300, provided by a graphical user interface of the deal structuring interface tool 110 of FIG. 1, to facilitate the associating of customer eligibility rules to discount deals by a user. As shown in FIG. 3, eligibility rules that include validity time periods and single or multi-use controls (i.e., redemption restrictions) may be associated with a discount deal.

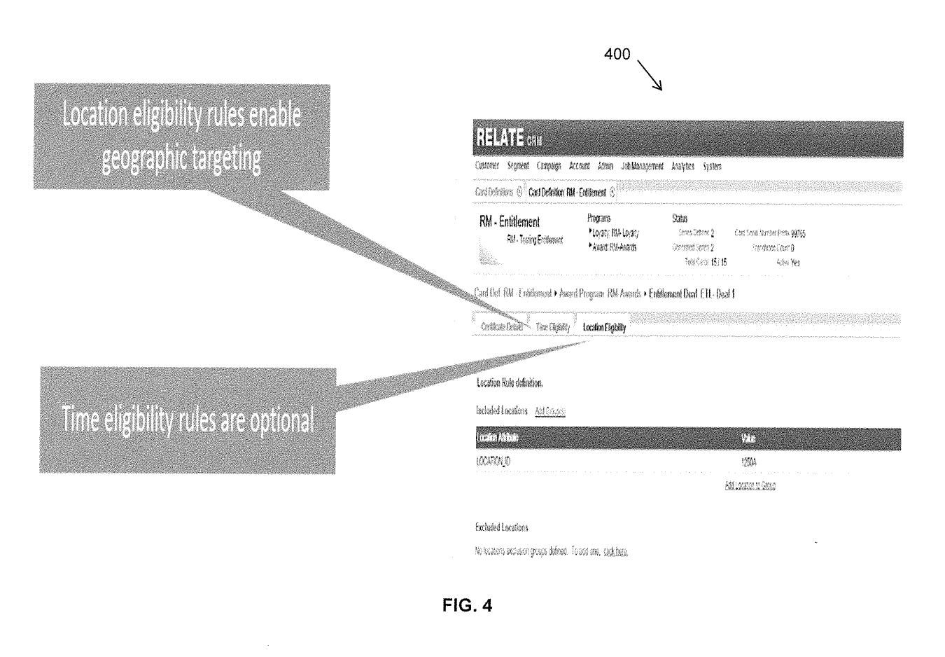

FIG. 4 illustrates another example embodiment of a screen shot 400, provided by a graphical user interface of the deal structuring interface tool 110 of FIG. 1, to facilitate the associating of customer eligibility rules to discount deals by a user. As shown in FIG. 4, eligibility rules that include location (e.g., store location) restrictions and time restrictions may be associated with a discount deal.

In this manner, blocks 210 to 240 of the method 200 allow a user to set up one or more deals that are associated with customer eligibility rules in the discounting service system 100. Specific deals are stored in a database device 199 associated with an application server (deal engine) 190. Customer eligibility rules are maintained within the deal structuring interface tool 110.

Continuing with the method 200, at block 250, customer data is received by the deal structuring interface tool 110 from the point-of-sale system 195. Deal structuring interface tool 110 is configured to operate with many different point-of-sale systems at multiple stores of a retailer, in accordance with one embodiment. The customer data is sent from the point-of-sale system 195 to the deal structuring interface tool 110 (e.g., via network communications) in response to a customer initiating a retail transaction at the retail store associated with the point-of-sale system 195. In one embodiment, the customer data includes data that identifies the customer (e.g., based on a loyalty card), the retail store, a current time of day, and a current day of the week.

At block 260, pre-evaluation logic 170 of the deal structuring interface tool 110 analyzes the customer data with respect to the eligibility rules that were set up and associated with the computerized discount object at block 240. The analysis determines whether the customer is currently eligible to take advantage of the specific deal defined by the computerized discount object (i.e., whether a current customer retail transaction is eligible to be modified by a transaction offset). For example, if the eligibility rules indicate that the customer is eligible to take advantage of the specific deal between 3:00 pm and 9:00 pm on weekdays, and it is currently Saturday, then the customer would currently be ineligible.

Upon determining at block 260 that the customer is currently eligible to take advantage of the specific deal then, at block 270, pre-evaluation logic 170 generates a computer message that identifies the computerized discount object. At block 280, pre-evaluation logic 170 transmits (e.g., via network communications) the computer message to the point-of-sale system 195. Discounting of a retail transaction of the customer by the deal engine is controlled based on the point-of-sale system 195 having knowledge of the identity of the computerized discount object. Again, the point-of-sale system 195 can send transaction data, corresponding to an initiated customer transaction, to the deal engine 190 (e.g., via network communications) along with the identifier of the computerized discount object. The transaction data includes information about the basket of retail items (identification of retail items, price, quantity, etc.).

In accordance with one embodiment, discounting of a retail transaction of a customer by the deal engine 190 includes reducing a price associated with the retail transaction based on the specific deal (transaction offset) defined by the computerized discount object. Note that, if the customer is determined to be ineligible for the deal at block 260, then blocks 270 and 280 are not performed. Furthermore, application of the specific deal to the customer transaction by the deal engine 190 is not performed.

In this manner, computerized discount objects defining core discount deals can be generated, stored, and processed separately from customer eligibility rules. As a result, discount deals can be generated or updated independent of the eligibility rules. Furthermore, a customer transaction can be evaluated with respect to customer eligibility before applying a discount deal to the customer transaction. If a customer is determined to be ineligible for a discount deal, then the system 100 does not have to waste time and resources applying the discount deal. This results in a retailer being able to provide a more efficient discounting service.

### Computing Device Embodiment

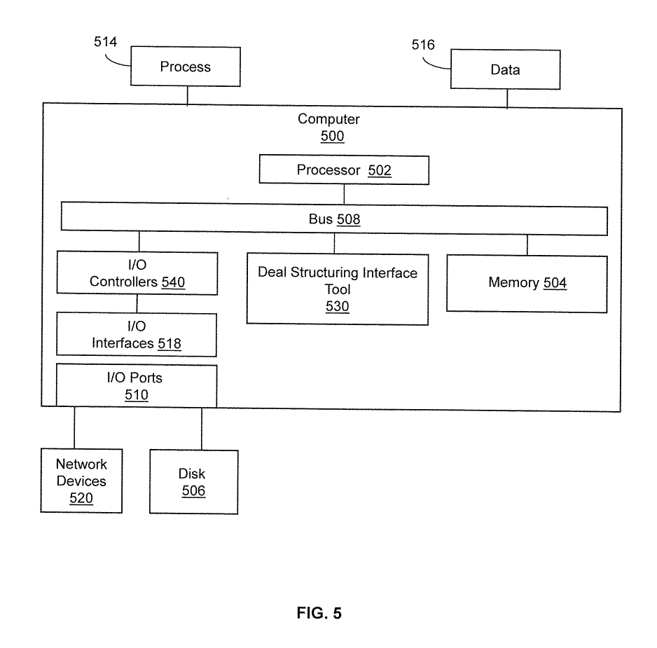

FIG. 5 illustrates an example computing device that is configured and/or programmed with one or more of the example systems and methods described herein, and/or equivalents. FIG. 5 illustrates one example embodiment of a computing device upon which an embodiment of a deal structuring interface tool may be implemented. The example computing device may be a computer 500 that includes a processor 502, a memory 504, and input/output ports 510 operably connected by a bus 508.

In one example, the computer 500 may include deal structuring interface tool 530 (corresponding to deal structuring interface tool 110 from FIG. 1) configured with a programmed algorithm as disclosed herein to allow for the structuring of deals as computerized discount objects. In different examples, the tool 530 may be implemented in hardware, a non-transitory computer-readable medium with stored instructions, firmware, and/or combinations thereof. While the tool 530 is illustrated as a hardware component attached to the bus 508, it is to be appreciated that in other embodiments, the tool 530 could be implemented in the processor 502, a module stored in memory 504, or a module stored in disk 506.

In one embodiment, tool 530 or the computer 500 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the structuring of deals as computerized discount objects. The means may also be implemented as stored computer executable instructions that are presented to computer 500 as data 516 that are temporarily stored in memory 504 and then executed by processor 502.

Tool 530 may also provide means (e.g., hardware, non-transitory computer-readable medium that stores executable instructions, firmware) for facilitating the structuring of deals as computerized discount objects.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A storage disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

Systems, methods, and other embodiments have been described that are configured to provide for the structuring of deals in such a way that core discount rules are separated from eligibility rules. In one embodiment, visual user interface logic is configured to provide a graphical user interface. Template selection logic is configured to facilitate, via the graphical user interface, selection by a user of a deal template from multiple deal templates. The deal template provides a computerized structure for generating deals used to discount retail transactions. Discount object creation logic is configured to transform the deal template into a computerized discount object by facilitating, via the graphical user interface, a structuring by the user of discount rules within the deal template to represent a specific deal. An application server is configured as a deal engine for applying deals to customer retail transactions. Publishing logic is configured to transmit the computerized discount object to the application server to be stored. Rules association logic is configured to facilitate, via the graphical user interface, associating by the user of the computerized discount object with the eligibility rules. The eligibility rules specify customer eligibility for taking advantage of the specific deal. Pre-evaluation logic is configured to receive customer data from a point-of-sale system at a retail store in response to a customer initiating a retail transaction via the retail store. Pre-evaluation logic is also configured to analyze the customer data with respect to the eligibility rules associated with the computerized discount object to determine whether the customer is currently eligible to take advantage of the specific deal. Pre-evaluation logic is further configured to, upon determining that the customer is currently eligible to take advantage of the specific deal, generate a computer message that identifies the computerized discount object and transmit the computer message to the point-of-sale system. In this manner, discounting of the retail transaction of the customer by the deal engine may be controlled based on the computerized discount object.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). An operable connection may include one entity generating data and storing the data in a memory, and another entity retrieving that data from the memory via, for example, instruction control. Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A computer-implemented method performed by a computing device where the computing device includes at least one processor for executing instructions from a memory, the method comprising:
facilitating, via a graphical user interface, a selection of a deal template from a plurality of deal templates, wherein the deal template provides a computerized structure for generating transaction offsets used to discount retail transactions;
transforming, by the at least one processor, the deal template into a computerized discount object at least in part by facilitating, via the graphical user interface, a structuring of discount rules within the deal template to represent a first transaction offset;
saving the computerized discount object, via network communications, to an application server configured to apply transaction offsets to retail transactions;
facilitating, via the graphical user interface, associating of the computerized discount object with eligibility rules, wherein the eligibility rules specify an eligibility for a retail transaction to be modified by the first transaction offset;
receiving customer data, via the network communications, from a point-of-sale system at a retail store in response to a retail transaction being initiated via the retail store;
analyzing, via the at least one processor, the customer data with respect to the eligibility rules associated with the computerized discount object to determine whether the retail transaction is eligible to be modified by the first transaction offset; and
upon determining that the retail transaction is eligible to be modified by the first transaction offset:
generating a computer message, via the at least one processor, that identifies the computerized discount object, and
transmitting the computer message, via the network communications, to the point-of-sale system to control a discounting of the retail transaction by applying the first transaction offset based on the computerized discount object.

2. The method of claim 1, wherein the discounting of the retail transaction includes reducing a price associated with the retail transaction based on the first transaction offset of the computerized discount object.

3. The method of claim 1, wherein the discount rules include trigger rules and award rules, and wherein the trigger rules cause the award rules to be applied to the retail transaction to affect a discount.

4. The method of claim 1, wherein the eligibility rules specify eligible retail stores, eligible times of day, eligible days of a week, and an eligible number of available redemptions for the first transaction offset.

5. The method of claim 1, wherein the retail store includes one of a physical store or an on-line store.

6. The method of claim 1, wherein the customer data includes data identifying at least one of a customer based on a loyalty card, the retail store, a current time of day, and a current day of a week.

7. The method of claim 1, further comprising receiving an identifier from the application server that identifies the computerized discount object as saved.

8. The method of claim 1, wherein the discount rules representing the first transaction offset include rules associated with a quantity and a price of a retail item.

9. The method of claim 1, wherein the saving of the computerized discount object to the application server includes saving the computerized discount object to a library of deals configured in a database device associated with the deal engine.

10. The method of claim 1, wherein the retail transaction includes a transaction of purchasing a plurality of retail items by a customer from the retail store.

11. A computing system, comprising:
a visual user interface module stored in a non-transitory computer-readable medium and including instructions that when executed generate a graphical user interface on a display screen of the computing system;
a template selection module, stored in the non-transitory computer-readable medium and including instructions configured to facilitate, via the graphical user interface, a selection of a deal template from a plurality of deal templates, wherein the deal template provides a computerized structure for generating transaction offsets used to discount retail transactions;
a discount object creation module stored in the non-transitory computer-readable medium and including instructions configured to transform the deal template into a computerized discount object at least in part by facilitating, via the graphical user interface, a structuring of discount rules within the deal template to represent a first transaction offset;
an application server configured to apply transaction offsets to retail transactions;
a publishing module stored in the non-transitory computer-readable medium and including instructions configured to transmit the computerized discount object to the application server to be stored; and
a rules association module stored in the non-transitory computer-readable medium and including instructions configured to facilitate, via the graphical user, associating of the computerized discount object with eligibility rules, wherein the eligibility rules specify an eligibility for a retail transaction to be modified by the first transaction offset.

12. The computing system of claim 11, further comprising a pre-evaluation module, stored in the non-transitory computer-readable medium and including instructions configured to:
receive customer data from a point-of-sale system at a retail store in response to a retail transaction being initiated via the retail store;
analyze the customer data with respect to the eligibility rules associated with the computerized discount object to determine whether the retail transaction is eligible to be modified by the first transaction offset; and
upon determining that the retail transaction is eligible to be modified by the first transaction offset:
generate a computer message that identifies the computerized discount object, and
transmit the computer message to the point-of-sale system to control a discounting of the retail transaction by applying the first transaction offset based on the computerized discount object.

13. The computing system of claim 11, further comprising a display screen configured to display and facilitate user interaction with at least the graphical user interface.

14. The computing system of claim 11, wherein the application server is configured to apply the first transaction offset to the retail transaction at least in part by reducing a price associated with the retail transaction based on the first transaction offset of the computerized discount object.

15. The computing system of claim 11, further comprising a database device associated with the application server and configured to store a library of deals as computerized discount objects.

16. The computing system of claim 11, wherein the discount rules include trigger rules and award rules, and wherein the trigger rules cause the award rules to be applied to the retail transaction by the application server to affect a discount.

17. The computing system of claim 11, wherein the rules association module is configured to facilitate, via the graphical user interface, generation of the eligibility rules.

18. A non-transitory computer-readable medium storing computer-executable instructions that, when executed by a computer, cause the computer to perform functions, wherein the instructions comprise:
instructions for facilitating a selection of a deal template from a plurality of deal templates, wherein the deal template provides a computerized structure for generating transaction offsets used to discount retail transactions;
instructions for facilitating a structuring of discount rules within the deal template to form a computerized discount object representing a first transaction offset;
instructions for saving the computerized discount object to an application server configured to apply transaction offsets to retail transactions;
instructions for facilitating associating of the computerized discount object with eligibility rules, wherein the eligibility rules specify an eligibility for a retail transaction to be modified by the first transaction offset;
instructions for receiving customer data from a point-of-sale system at a retail store in response to a retail transaction being initiated via the retail store;
instructions for analyzing the customer data with respect to the eligibility rules associated with the computerized discount object to determine whether the retail transaction is eligible to be modified by the first transaction offset;
instructions for generating a computer message that identifies the computerized discount object; and
instructions for transmitting the computer message to the point-of-sale system to control a discounting of the retail transaction by applying the first transaction offset based on the computerized discount object.

19. The non-transitory computer-readable medium of claim 18, wherein the instructions further include instructions for receiving an identifier from the application server that identifies the computerized discount object as saved.

20. The non-transitory computer-readable medium of claim 18, wherein the instructions further include instructions for providing a graphical user interface.
